(19) United States
(12) Patent Application Publication
(10) Pub. No.: US 2016/0059364 A1
(43) Pub. Date: Mar. 3, 2016

(54) WIDE GAP BRAZE

(71) Applicant: UNITED TECHNOLOGIES CORPORATION, Hartford, CT (US)

(72) Inventor: Jason E. Huxol, Hondo, TX (US)

(21) Appl. No.: 14/783,051

(22) PCT Filed: Apr. 10, 2014
(86) PCT No.: PCT/US14/33642

§ 371 Date: Oct. 7, 2015

Related U.S. Application Data
(60) Provisional application No. 61/811,502, filed on Apr. 12, 2013.

(51) Int. Cl. B23P 6/04; B23K 37/00; F01D 5/00; F01D 5/22; F01D 5/14; F01D 9/04; B23K 1/008; B23K 35/36

(52) U.S. Cl. CPC B23P 6/045; B23K 1/008; B23K 37/00; B23K 35/36; F01D 5/225; F01D 5/147; F01D 9/041; F01D 5/005; F05D 2220/32; F05D 2230/237; F05D 2240/30; F05D 2240/12; F05D 2230/80; F05D 2300/17; F05D 2300/615

(57) ABSTRACT

A method to fill a gap in a component according to one disclosed non-limiting embodiment of the present disclosure includes applying an alloy powder onto the component such that the alloy powder is received into a gap in response to vibrating of the component.

This application claims priority to U.S. Patent Appln. No. 61/811,502 filed Apr. 12, 2013.

### BACKGROUND

The present disclosure relates generally to methods and apparatuses for a wide gap braze.

Gas turbine components, such as superalloy blades and vanes, are subjected to high temperatures and stresses under engine operation. Under such conditions the components may form gaps such as cracks, voids and worn surfaces. When the gaps extend beyond certain allowable limits, a decision must be made to either repair or replace the components. There may often be considerable economic incentives to repair the components by methods such as welding, brazing or wide-gap brazing.

Wide-gap brazing refers to the repair of defects too large to be filled or bridged by standard brazing techniques wherein the gap filler material is drawn into defects by capillary forces alone. Therefore, wide-gap filler materials must be physically pre-placed within the gaps to prevent the braze from substantially flowing out of the repair area.

While wide-gap slurries, pastes and transfer tapes are useful for some repairs, there are many situations in which these materials are unsatisfactory. Wide gaps that are greater than about 0.004″ (0.1 mm), when repaired with the typical overlayment of a bi-modal braze, often result in voids due to poor capillary action and centerline eutectic formation. Alternatively, the cracks are sprinkled with base alloy powder but such application is often incomplete. Another alternative is the utilization of a metallic putty. The putty, however, cannot effectively be forced into common gap widths of 0.004″ to 0.030″ (0.1-0.8 mm).

### SUMMARY

A method to fill a gap in a component according to one disclosed non-limiting embodiment of the present disclosure includes applying an alloy powder onto the component such that the alloy powder is received into a gap in response to vibrating of the component.

A further embodiment of the present disclosure includes capping the alloy powder within the gap with a bi-modal braze composition.

A further embodiment of any of the foregoing embodiments of the present disclosure includes applying the bi-modal braze composition as a bead.

A further embodiment of any of the foregoing embodiments of the present disclosure includes applying the bi-modal braze composition with a syringe.

A further embodiment of any of the foregoing embodiments of the present disclosure includes utilizing a combination of an alloy powder; an alloy powder with a melting point depressant; and a braze binder as the bi-modal braze composition.

A further embodiment of any of the foregoing embodiments of the present disclosure includes utilizing a combination of 50-80% alloy powder; a 10% braze binder; and a remainder of an alloy powder with a melting point depressant as the bi-modal braze composition.

A further embodiment of any of the foregoing embodiments of the present disclosure includes orienting the component so the gap is generally upwards with respect to gravity.

A further embodiment of any of the foregoing embodiments of the present disclosure includes brazing the component within a furnace.

A method for repairing an aerospace component according to another disclosed non-limiting embodiment of the present disclosure includes applying an alloy powder onto the component such that the alloy powder is received into a gap in response to the vibrating of the aerospace component; and capping the alloy powder within the gap.

A further embodiment of any of the foregoing embodiments of the present disclosure includes orienting the component so the gap is generally upwards with respect to gravity.

A further embodiment of any of the foregoing embodiments of the present disclosure includes applying the bi-modal braze composition as a bead.

A further embodiment of any of the foregoing embodiments of the present disclosure includes applying the bi-modal braze composition with a syringe.

A further embodiment of any of the foregoing embodiments of the present disclosure includes brazing the component within a furnace.

In a further embodiment of any of the foregoing embodiments of the present disclosure, the aerospace component includes a vane.

In a further embodiment of any of the foregoing embodiments of the present disclosure, the aerospace component is a blade.

An aerospace component according to another disclosed non-limiting embodiment of the present disclosure includes a gap filled with a melted alloy powder and capped with a bi-modal braze composition.

In a further embodiment of any of the foregoing embodiments of the present disclosure, the aerospace component is a blade.

In a further embodiment of any of the foregoing embodiments of the present disclosure, the aerospace component is a vane.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of an aerospace component;

FIG. 2 is a perspective view of another aerospace component;

FIG. 3 is a perspective view of another aerospace component;

FIG. 4 is schematic block diagram of a method to repair the aerospace component; and

FIG. 5 is an expanded cross-sectional view of a gap repair according to the method disclosed in FIG. 4.

### DETAILED DESCRIPTION

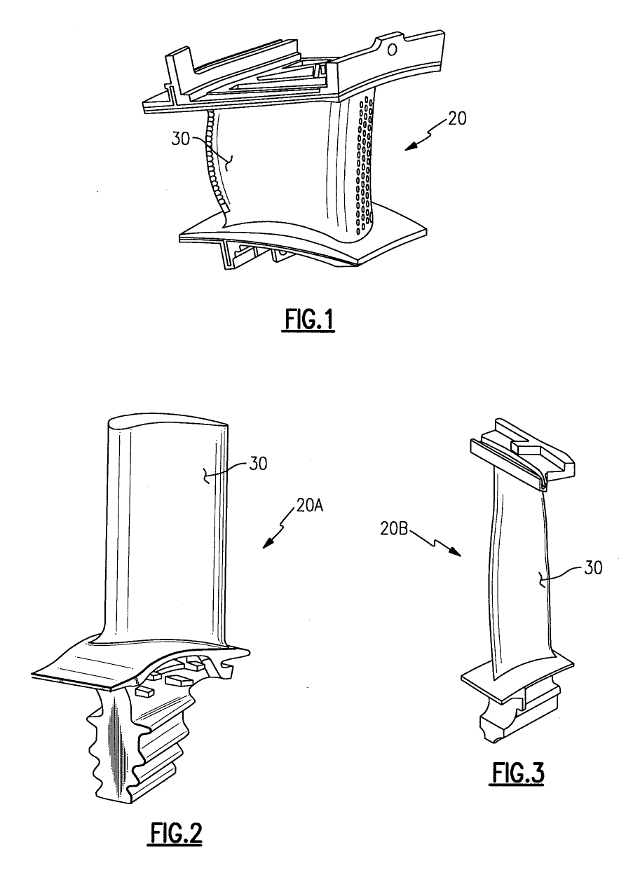

FIG. 1 schematically illustrates a component 20 with a gap 30 (illustrated schematically and exaggerated) such as a crack, void, worn surface or other defect. The component 20 may be an aero or aero derivative gas turbine engine component such as a vane (FIG. 1), a blade 20A (FIG. 2), a shrouded blade 20B (FIG. 3), or other component.

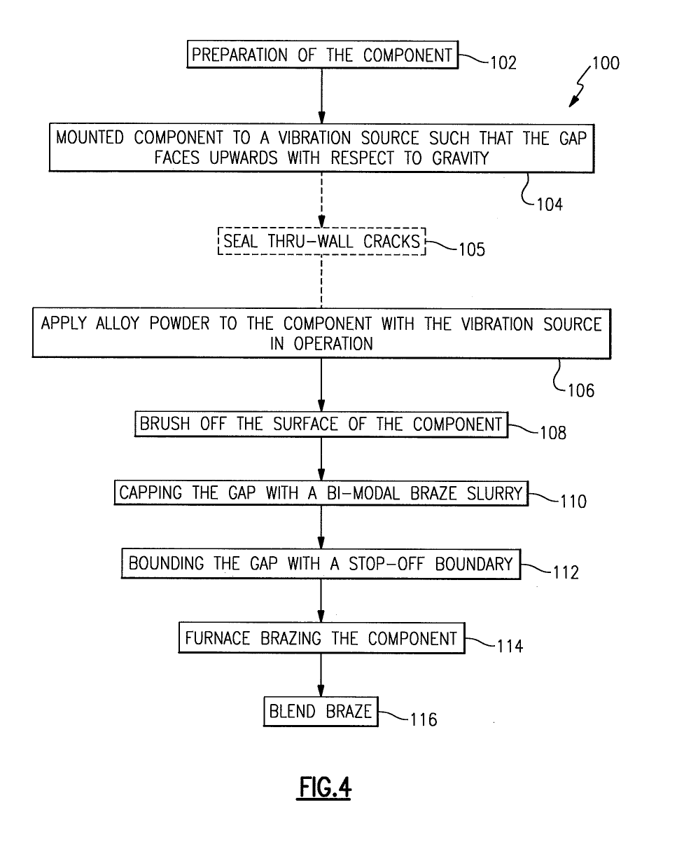

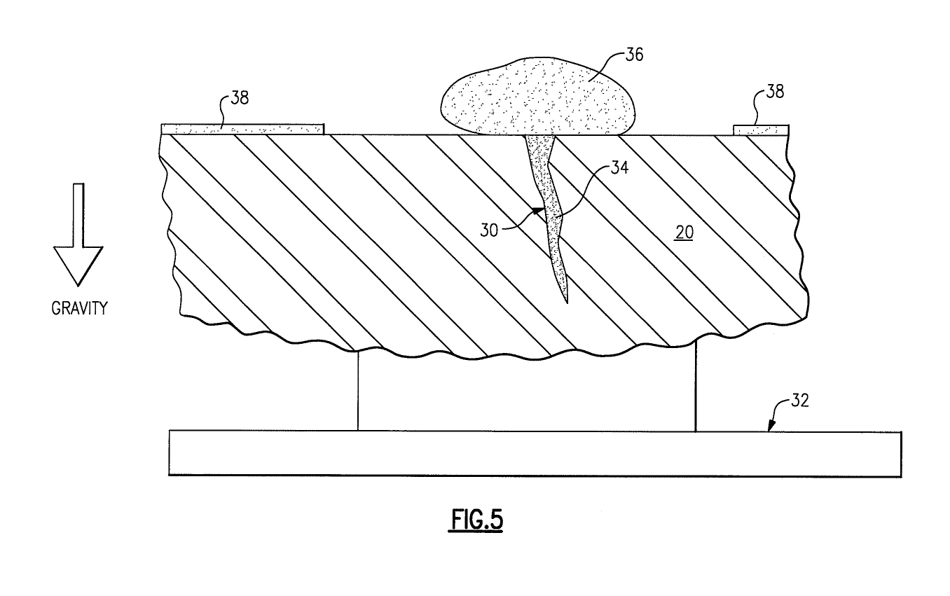

With reference to FIG. 4, one disclosed non-limiting embodiment of a repair method 100 initially includes preparation of the component 20 (step 102) such as by fluoride-ion cleaning to remove combustion gas formed oxides from the gap 30. It should be appreciated that alternative or additional cleaning and preparation steps to facilitate the method may alternatively be performed.

The component 20 is then mounted to a vibration source 32 (step 104; FIG. 5 illustrated schematically) such as a vibration table, air vibrator or other support such that the gap 30 faces substantially upwards with respect to gravity. It should be appreciated that various vibration sources may be utilized.

An alloy powder 34, inclusive of nano sized alloy particles, is then applied to the component 20 with the vibration source 32 in operation (step 106). The alloy powder 34 may be equivalent or different than the base material of the gas turbine component 20 such as a nickel-based superalloy or combinations thereof. That is, the alloy powder 34 may be the same or a stronger material alloy than that of the component 20 base alloy.

The vibration generated by the vibration source 32 essentially fluidizes the powder so that the powder readily penetrates into and fills the gap 30. As the gap 30 faces upwards with respect to gravity, the alloy powder 34 is readily received within the gap 30. It should be appreciated that multiple cracks 30 are readily filled. For thru-wall cracks, a braze composition/paint may first be applied to a bottom side of the gap 30 (step 105) prior to the vibration fill step 106.

Once filled, the remainder of the alloy powder 34 is brushed off the surface of the component 20 (step 108). It should be appreciated that other removal processes that do not disturb the alloy powder 34 within the gap 30 may alternatively be utilized.

Then, a bi-modal braze composition 36 is applied over the gap 30 to cap the alloy powder 34 therein (step 110; FIG. 5). The bi-modal braze composition 36 may be applied as a relatively thin bead with, for example, a surgical syringe or other precise applicator. That is, the bi-modal braze composition 36 is essentially a slurry. The bi-modal braze composition 36, in one disclosed non-limiting embodiment, includes a combination of: base power alloy; alloy powder with a melting point depressant such as boron; and a braze binder such as an organic vehicle like cellulose. For example, the bi-modal braze composition 36 includes 50-80% base power alloy; 10% braze binder and the remainder with the alloy powder with melting point depressant. Various other combinations and ingredients may alternatively be utilized so as cap the alloy powder 34 within the crack 30.

A stop-off boundary 38 may then be applied to bound the gap 30 (step 112). The stop-off boundary may be an oxide composition or other material to bound the braze area.

The component 20 is then placed into a vacuum furnace to be brazed (step 114). Finally, the braze may blended into the surface of the component 20 (step 116). The blend may be performed by hand or by machine operation.

The repair method 100 reduces the required braze volume which thereby reduces the brittle phase forming constituents and increases capillary forces for the braze metal to flow and hereby minimize or eliminate voids in the gap 30. That is, the solidification front is divided among multiple areas by the alloy powder 34 which results in inert eutectic formations rather than a linear formation known as a “centerline” eutectic which may crack once stress is applied.

Testing has shown that the vibration based repair method 100 improves microstructure over conventional bimodal sprinkled powder and putty. Furthermore, conventional bimodal repairs are not applicable to cracks over 0.004 inches (0.1 mm) and maybe but a cosmetic repair due to centerline eutectic. Sprinkling with base alloy powder does not completely fill the cracks while usage of putty results in voids and excess braze due to the volume of space left after the binder vaporizes.

More precise repairs are facilitated and cracks between 0.001 and 0.005 inches (0.025-0.127 mm) are readily achievable with this method. That is, gaps that are otherwise too wide for braze capillary action are readily filled. Repairs that employ embodiments of that disclosed herein therefore reduce repair time and cost, and simultaneously improve repair quality.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A method to fill a gap in a component comprising:
vibrating the component; and
applying an alloy powder onto the component such that the alloy powder is received into a gap in response to the vibrating of the component.

2. The method as recited in claim 1, further comprising:
capping the alloy powder within the gap with a bi-modal braze composition.

3. The method as recited in claim 2, further comprising:
applying the bi-modal braze composition as a bead.

4. The method as recited in claim 3, further comprising:
applying the bi-modal braze composition with a syringe.

5. The method as recited in claim 2, further comprising:
utilizing a combination of an alloy powder; an alloy powder with a melting point depressant; and a braze binder as the bi-modal braze composition.

6. The method as recited in claim 2, further comprising:
utilizing a combination of 50-80% alloy powder; a 10% braze binder; and a remainder of an alloy powder with a melting point depressant as the bi-modal braze composition.

7. The method as recited in claim 2, further comprising:
orienting the component so the gap is generally upwards with respect to gravity.

8. The method as recited in claim 2, further comprising:
brazing the component within a furnace.

9. A method for repairing a gas turbine engine component comprising:
vibrating the aerospace component;
applying an alloy powder onto the component such that the alloy powder is received into a gap in response to the vibrating of the aerospace component; and
capping the alloy powder within the gap.

10. The method as recited in claim 9, further comprising:
orienting the component so the gap is generally upwards with respect to gravity.

11. The method as recited in claim 10, further comprising:
applying the bi-modal braze composition as a bead.

12. The method as recited in claim 11, further comprising:
applying the bi-modal braze composition with a syringe.

13. The method as recited in claim 10, further comprising:
brazing the component within a furnace.

14. The method as recited in claim 10, wherein the aerospace component is a vane.

15. The method as recited in claim 10, wherein the aerospace component is a blade.

16. A gas turbine engine component comprising:
a gap filled with a melted alloy powder and capped with a bi-modal braze composition.

17. The gas turbine engine component as recited in claim 16, wherein the aerospace component is a blade.

18. The gas turbine engine component as recited in claim 16, wherein the aerospace component is a vane.
